(19) United States
(12) Patent Application Publication
(10) Pub. No.: US 2026/0094168 A1
(43) Pub. Date: Apr. 2, 2026

(54) SYSTEM AND METHOD FOR FINANCIAL REGULATORY AND COMPLIANCE RULES MANAGEMENT USING A CUSTOMIZED DOMAIN-SPECIFIC LANGUAGE

(71) Applicant: WELLS FARGO BANK, N.A., San Francisco, CA (US)

(72) Inventors: Balakrishna Katamarthini, Hyderabad (IN); Venkata Bulusu, Hyderabad (IN); Mamta Annigeri, Hyderabad (IN); Janakirama V. Bhupathiraju, Hyderabad (IN); Stephanie Ikeda Yasuda, Monterey, CA (US); Maniappan Uppliappan, Chennai (IN)

(21) Appl. No.: 18/904,652

(22) Filed: Oct. 2, 2024

(51) Int. Cl. G06Q 30/018

(52) U.S. Cl. CPC G06Q 30/018

(57) ABSTRACT

Systems and methods for generating executable rules using a domain specific language (DSL) are provided. A method includes accessing a first set of documents and extracting semantic features from the first set of documents. The method also includes transforming the semantic features into lower-dimensional features and mapping the lower-dimensional features to a domain-specific language (DSL). The method also includes compiling the DSL rules and storing the executable rules in a rules repository. The method also includes executing the executable rules against one or more documents from a second set of documents to generate a response and providing the response to a downstream operating service.

### TECHNICAL FIELD

The present disclosure generally relates to natural language processing, and more particularly to integrated techniques for generating executable rules using a domain specific language (DSL).

### BACKGROUND

In an enterprise setting, institutions are subject to a myriad of complex regulatory requirements. The regulatory requirements often reside in many forms such as memorandums, policy documents, tables, notes, or other data sources. The variability and continual updates to these regulatory requirements is a source of significant inefficiencies in the way data is made available for different applications such as monitoring, interpretation, and compliance in the enterprise setting. For example, existing compliance management systems often rely on manual processes to implement data extraction, interpretation, and implementation between each data source and each application. However, these manual processes are not able to deal with the various types of data in an efficient manner thereby resulting in incomplete and potentially inaccurate evaluation of compliance with regulatory requirements. The inefficiencies and inaccuracies further lead to negative consequences in downstream decision-making processes that can cause errors and increased operational costs.

### SUMMARY

Certain aspects and features of the present disclosure generally relate to natural language processing, and more particularly to integrated techniques for generating executable rules using a domain specific language (DSL). According to an aspect of the present disclosure, a method for generating executable rules using a domain specific language (DSL) is provided. The method includes accessing a first set of documents comprising text data; extracting a set of semantic features from the first set of documents using a first natural language processing (NLP) model of a rule builder engine, wherein each document from the first set of documents includes one or more semantic features; transforming the set of semantic features into a set of lower-dimensional features using a semantic parser of a rule builder engine; mapping the lower-dimensional features to a domain-specific language (DSL) rule to thereby generate a set of DSL rules; compiling the set of DSL rules using a rules compiler module of the rules building engine to generate a set of executable rules; storing the set of executable rules in a rules repository for access by a rule execution engine, wherein one or more executable rules are executed against one or more documents from a second set of documents received by the rule execution engine to generate a response; and providing the response to a downstream operating service.

In some examples, the first set of documents may be stored in a publicly accessible database, where a first document of the first set of documents is associated with a first predefined policy and a second document of the first set of documents is associated with a second predefined policy. In some examples, the method further includes: querying the publicly accessible database to identify a third document associated with a third predefined policy; comparing the third predefined policy of the third document to one or more of the first predefined policy or the second predefined policy to determine whether the third predefined policy is associated with an update to the first predefined policy or the second predefined policy or whether the third predefined policy is a new predefined policy; updating the first set of documents to include the third document and to remove one or more of the first document or the second document when the third predefined policy is associated with an update to the first predefined policy or the second predefined policy; and updating the first set of documents to include the first document, the second document, and the third document when the third predefined policy is a new predefined policy. In some examples, querying the publicly accessible database is performed periodically.

In some examples, the method includes providing the first set of documents to a second NLP model of the rule builder engine, wherein the second NLP model is trained to identify one or more patterns associated with the first set of documents; generating, using the second NLP model, a third set of documents having a predicted set of semantic features, and wherein the third set of documents is generated based on one or more patterns associated with the first set of documents; providing the predicted set of semantic features to the semantic parser of the rule builder engine to generate a second set of lower-dimensional features; mapping the second set of lower-dimensional features to the domain-specific language (DSL) rule to thereby generate a predicted set of DSL rules; compiling the predicted set of DSL rules using the rules compiler module to generate a set of predicted executable rules; and storing the set of predicted executable rules in the rules repository for access by a rule execution engine.

In some examples, the second set of documents is associated with user financial data. In some examples, the response is associated with an alert of compliance or non-compliance with a predefined policy associated with at least one document of the first set of documents. In some examples, the downstream operating service comprises a message queue and the method further includes generating an alert based on the response, where the alert is automatically generated by the rule execution engine, and where the alert is posted to the message queue.

In some examples, the method for generating executable rules using a domain specific language (DSL) can further include modifying one or more of the executable rules using a user interface of the downstream operating service and based on user adjustable parameters to create a modified executable rule; and storing the modified executable rule in the rules repository.

The above methods may be implemented in a cloud service executed on cloud service provider infrastructure, which may include various servers, processors, and databases. The above methods can also be implemented as computer-executable program instructions stored in a non-transitory, tangible computer-readable medium or media and/or operating within a system including one or more processors or other processing device and memory.

An additional example includes a system including one or more processors. The system also includes a memory coupled to the one or more processors. The memory includes instructions that when executed by the one or more processors, causes the one or more processors to: access a first set of documents comprising text data; extract a set of semantic features from the first set of documents using a first natural language processing (NLP) model of a rule builder engine, wherein each document from the first set of documents includes one or more semantic features; transform the set of semantic features into a set of lower-dimensional features using a semantic parser of a rule builder engine; map the lower-dimensional features to a domain-specific language (DSL) rule to thereby generate a set of DSL rules; compile the set of DSL rules using a rules compiler module of the rules building engine to generate a set of executable rules; store the set of executable rules in a rules repository for access by a rule execution engine, wherein one or more executable rules are executed against one or more documents from a second set of documents received by the rule execution engine to generate a response; and provide the response to a downstream operating service.

An additional example includes a non-transitory computer-readable medium embodying program code that is executable by one or more processors to cause the one or more processors to: access a first set of documents comprising text data; extract a set of semantic features from the first set of documents using a first natural language processing (NLP) model of a rule builder engine, wherein each document from the first set of documents includes one or more semantic features; transform the set of semantic features into a set of lower-dimensional features using a semantic parser of a rule builder engine; map the lower-dimensional features to a domain-specific language (DSL) rule to thereby generate a set of DSL rules; compile the set of DSL rules using a rules compiler module of the rules building engine to generate a set of executable rules; store the set of executable rules in a rules repository for access by a rule execution engine, wherein one or more executable rules are executed against one or more documents from a second set of documents received by the rule execution engine to generate a response; and provide the response to a downstream operating service.

Numerous benefits are achieved by way of the various embodiments over conventional techniques. For example, by leveraging the innovative techniques described herein, an advanced rule builder engine utilizing a customized DSL can achieve greater compliance efficiency, reduce regulatory risks, and enhance overall governance in the enterprise setting where regulatory requirements are complex and rapidly evolving. In particular, the techniques leverage Financial Regulatory Specification Language (FRSL) which is a specialized DSL tailored to the specific domain and application applicable to financial regulations. The proposed techniques automate rule definition, evaluation, and enforcement, thereby improving accuracy, efficiency, and transparency in compliance management. In other words, the techniques allow creation of model workflows that can become functional with minimal manual intervention. The automation creates a consistent mechanism for compliance monitoring, reporting, and remediation thereby improving upon operational efficiencies in the enterprise setting.

This summary is not intended to identify the key or essential features of the claimed subject matter, nor is it intended to be used in isolation to determine the scope of the claimed subject matter. Rather, the summary is merely a simplified and non-limiting summary of the innovation that is intended to provide a basic understanding of some aspects of the innovation. The subject matter should be understood by reference to appropriate portions of the entire specification of this disclosure, any or all drawings, and each claim.

To the accomplishment of the foregoing and related ends, certain illustrative aspects of the innovation are described herein in connection with the following description and the annexed drawings. These aspects are indicative, however, of but a few of the various ways in which the principles of the innovation may be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Various non-limiting embodiments are further described with reference to the accompanying drawings, in which:

FIG. 1 is a block diagram illustrating an example computing environment for rules management using a DSL, according to one or more aspects of the present disclosure;

FIG. 2 is a block diagram illustrating an example computing platform for rules management using a DSL, according to one or more aspects of the present disclosure;

FIG. 3 is a block diagram illustrating an example analysis pipeline of the computing platform of FIG. 2 used for rules management, according to one or more aspects of the present disclosure;

FIG. 4 is a flowchart of an example of a process for rules management using a DSL, according to one or more aspects of the present disclosure;

FIG. 5 is a block diagram illustrating an example computer-readable medium or computer-readable device including processor-executable instructions configured to embody one or more aspects of the present disclosure; and

FIG. 6 and the following discussion provide a description of a suitable computing environment to implement embodiments of one or more aspects of the present disclosure.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The words “exemplary” or “example” are used herein to mean “serving as an example, instance, or illustration.” Any embodiment or design described herein as “exemplary,” or “example” is not necessarily to be construed as preferred or advantageous over other embodiments or designs.

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

Illustrative Example for Financial Regulatory and Compliance Rules Management using a Customized DSL

One illustrative example of the present disclosure includes systems and methods for managing financial regulatory and compliance rules through a customized FRSL DSL. The techniques enable generation of executable rules stored in a generic rule repository where the executable rules are associated with regulatory requirements. As used herein, the regulatory requirements may be associated with predefined policies published or otherwise made available by regulatory agencies. An enterprise may use the executable rules to evaluate evaluation data (e.g., user/customer data) to determine compliance risks. Thus, the techniques described herein streamline compliance processes, enhance regulatory adherence, and facilitate automated monitoring and reporting for financial institutions.

In particular, the techniques described herein generate executable rules by mining (e.g., accessing) one or more data sources in any of various formats and by using natural language processing (NLP) techniques to interpret regulatory specific language included in the one or more data sources. From this interpretation, regulatory requirements are converted into the FRSL DSL to generate executable rules in a specialized language tailored specifically to the domain of defining and managing financial regulations. In other words, the FRSL DSL is designed with syntax and semantics that align closely with extracted regulatory requirements gathered from publicly available sources. The techniques enable intuitive and effective compliance evaluations for institutions and can further be extended to incorporate new regulatory requirements, allowing for quick adaption to rapid changes in the regulatory environment without the need for significant overhauls to the existing computational infrastructure. Thus, the techniques may reduce the overall true cost associated with monitoring and ensuring compliance with the myriad of complex regulatory requirements that enterprises, and in particular, financial institutions, may be subject to.

The techniques described herein also provide an advanced rule management engine described as a rule builder engine. The rule builder engine includes a visual rule editor and templates that allows users to create, modify and save executable rules using a user-friendly drag-and-drop interface. The user-friendly drag and drop interface simplifies the process of formulating FRSL DSL executable rules for non-technical users thus enhancing usability and accessibility. Techniques described herein also provide for a centralized database described as a rules repository specifically designed to store executable rules generated by the rule builder engine. A centralized rules repository ensures the executable rules are easily accessible, well-organized, and manageable for users in the enterprise.

The techniques described herein also include a comprehensive compliance monitoring and alerting capabilities by way of a rule execution engine providing evaluation and output for downstream services. A key aspect of the rule execution engine and services is the continuous, real-time monitoring of financial transactions and activities to ensure enterprise compliance with defined rules. Thus, the techniques provided by the present disclosure provide for a proactive approach to regulatory compliance through immediate detection, remediation, and dynamic compliance management as compared to legacy techniques, such as periodic checks and audits. Further, enhanced alerting provided as a part of downstream services enable immediate notification of potential issues (e.g., compliance/non-compliance issues) thus allowing for quicker resolution.

The techniques described herein also leverage the use of machine learning and artificial intelligence (AI) to provide predictive and advisory features. In other words, the techniques utilize machine learning and AI to predict future regulatory changes based on current trends and historical data thereby offering foresight and enabling proactive adjustments to compliance strategies. Automated compliance advisory services provide recommendations and best practices, leveraging AI for more informed decision-making.

The techniques described herein also can provide for interactive training and certification programs to users. For example, the systems and methods can include interactive training modules to help users understand regulatory requirements and how to use one or more of the rule builder engine or the rule execution engine most effectively. These instructional capabilities address the educational gap often present in compliance tools, and certification programs may ensure that users are proficient in using the system and comprehending compliance regulations, adding an additional layer of value to enterprises.

While certain embodiments are described, these embodiments are presented by way of example only and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection. Further details regarding the systems and methods are provided below in relation to the drawings.

Illustrative Systems and Methods for Financial Regulatory and Compliance Rules Management using a Customized DSL

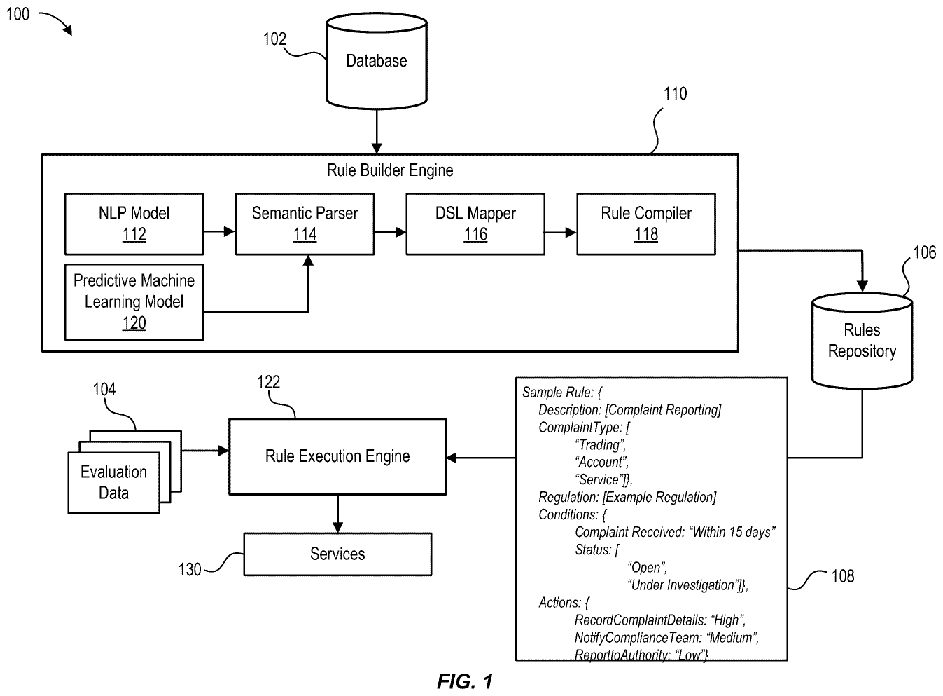

Turning now to the figures, FIG. 1 is a block diagram illustrating an example computing environment 100 for rules management using a DSL, according to one or more aspects of the present disclosure. The techniques described in relation to the computing environment 100 are described in relation to providing executable rules using a customized DSL for evaluating evaluation data 104 and providing outputs for downstream services such as service 130. As shown in FIG. 1, computing environment 100 can include a rule builder engine 110. The rule builder engine 110 can include various subsystems. For example, the rule builder engine 110 can include an NLP model 112, a semantic parser 114, a DSL mapper 116, a rule compiler 118, and a predictive machine learning model 120 for generating executable rules based on input data from database 102. The executable rules may be stored in rules repository 106 for access by rule execution engine 122. Rule execution engine 122 may also receive evaluation data 104 and evaluate the evaluation data 104 using the executable rules. The output response generated by the rule execution engine 122 may be provided to services 130. Services 130 may include a variety of downstream enterprise services that may response to the generated output.

Database 102 may include documents associated with regulatory requirements. In one example, database 102 may be a publicly accessible database. For example, rule builder engine 110 can access the documents stored in database 102 and perform processing on the documents. In some examples, the documents may be stored remotely (e.g., as part of a cloud computing system) and the rule builder engine 110 may remotely access the documents stored in database 102 to perform the operations described herein. Further, the documents stored in database 102 may be associated with various types of data sources corresponding to financial regulatory requirements that are posted or otherwise made available by various financial regulatory agencies. For example, one financial regulatory agency may include the Securities and Exchange Commission (SEC), and another financial regulatory agency may include the Financial Industry Regulatory Authority (FINRA). Each agency may publish regulatory requirements that are imposed on enterprises. Although only one database is illustrated in FIG. 1, rule builder engine 110 may access documents associated with regulatory requirements from more than one database. For example, regulatory requirements published by the SEC may be stored in one database, such as database 102, and regulatory requirements published by the FINRA may be stored in another database (not shown).

Rule builder engine 110 may access the documents described above stored in database 102 and perform processing operations on the documents. Included within the rule builder engine 110 may be various subsystems and tools utilized by the rule builder engine 110 to perform the operations of generating executable rules in a DSL. For example, rule builder engine 110 may include NLP model 112. NLP model 112 can take as input the set of documents accessed and retrieved from database 102 and extract semantic features from the set of documents to generate a set of semantic features where each semantic feature corresponds to a document from the set of documents. The semantic features can be associated with various rules, regulations, and requirements described by the document. Using NLP techniques, NLP model 112 can extract the semantic features from the documents to understand the natural language content included in the documents. Various NLP techniques may be used by NLP model 112 to perform semantic feature extraction on the set of documents. Various non-limiting semantic feature extraction techniques include a bag-of-words feature extraction, transforming the set of documents into vector embeddings, universal sentence encoders, term frequency-inverse document frequency (TF-IDF), and bidirectional encoder representations from transformers (BERT) techniques. One of ordinary skill in the art would recognize many variations, modifications, and alternatives.

Due to the high-dimensional nature of the semantic features extracted using the NLP model 112, the semantic features can be provided to a semantic parser 114 of the rule builder engine 110 to generate a set of lower-dimensional features from the semantic features. In an example, the semantic parser 114 can project the high dimensional features of the semantic features generated by the NLP model 112 to lower-dimensional features using various techniques for dimensional reduction such as singular value decomposition (SVD), principal component analysis, unform manifold approximation and projection (UMAP), and the like. In other words, the semantic parser 114 normalizes the semantic features extracted from the NLP model 112 into a structure format where the set of lower-dimensional feature are associated with a meaning and context of the semantic features from each document. Normalizing the set of semantic features converts the semantic features into a format suitable for further processing steps.

The lower-dimensional features that represent the documents accessed from database 102 may then be provided to DSL mapper 116 of rule builder engine 110. DSL mapper 116 performs the functions of translating the structured information associated with the lower-dimensional features generated from semantic parser 114 into the FRSL DSL. For example, the DSL mapper 116 maps the structured data to the specific syntax and semantics of the FRSL DSL to represent the rules and requirements accurately. The output from the DSL mapper 116 is a set of DSL rules associated with the lower-dimensional features of the documents from database 102. More specifically, DSL mapper 116 may adapt the lower-dimensional features to the specific domain of the FRSL DSL. In other words, the lower-dimensional features are fine-tuned to align with the domain-specific terminology, concepts, and relationships. As one example, in the financial domain, this may mean aligning the lower-dimensional features with financial terminologies (e.g., compliance, reporting, audit, etc.).

In one example, a regulatory requirement may require that a financial institution report any single transaction or series of linked transactions over a certain dollar amount to the relevant authority within a certain time frame. Based on this example, the NLP model 112 may extract a set of semantic features from the regulation. As described above, the set of semantic features may be high-dimensional. The set of semantic features can include the extracted transaction amount, the reporting threshold dollar amount, the reporting timeframe, and the relevant authorities to report the transaction to. The semantic parser 114 may then translate the set of semantic features to a lower-dimensional representation. For example, this can involve defining a transaction amount feature associated with a single numerical value representing the transaction amount (e.g., $10,000), a transaction report feature that is a binary value (e.g., 0 or 1) indicating whether the transaction has been reported, and a compliance status that is a categorical value (e.g., compliant or non-compliant) based on the transaction amount feature and the transaction report feature. These lower-dimensional features may be provided to the DSL mapper 116 and mapped to a specific FRSL DSL rule, as described in more detail below in relation to the rule compiler 118 and the sample rule 108. The lower-dimensional transformation simplifies the complex regulatory requirements into a format that is easier to programmatically analyze.

The set of DSL rules may then be provided to rule compiler 118 of the rule builder engine 110. The rule compiler 118 takes the FRSL formatted rules from the DSL mapper 116 and compiles the rules into a set of executable rules that can be processed by the rule execution engine 122. In other words, the rule compiler 118 evaluates each DSL rule generated by the DSL mapper 116. Each line of the DSL rule is converted from the source code associated with DSL mapper 116 (e.g., a higher level of abstraction) into machine readable code (e.g., bytecode, computer-readable media, etc.). Thus, the rule compiler 118 prepares the DSL rules to be executed by the rule execution engine 122.

Also included in rule builder engine 110 can be predictive machine learning model 120. Predictive machine learning model 120 can be a supervised machine learning model or an unsupervised machine learning that employs techniques to detect patterns in historical regulatory changes. For example, predictive machine learning model 120 may identify that certain economic downturns or political shifts can lead to increased regulation in specific industries. This predictive capability can also perform time series analysis and trend prediction to determine a likelihood of regulatory changes based on historical patterns and current data. Further, predictive machine learning model 120 can perform classification tasks on the documents accessed from database 102. For instance, predictive machine learning model 120 can categorize documents based on topic (e.g., finance regulations, data privacy regulations, environmental regulations, etc.) and predict future changes within specific regulatory areas.

According to one example, predictive machine learning model 120 can be trained to detect patterns in regulatory documents. More particularly, the predictive machine learning model 120 would ingest and analyze various data sources such as regulatory documents, amendments, legal rules, and past changes to identify trends and patterns. This information may be scrapped from government agency websites, regulatory bodies, legal databases, and other authoritative sources. The predictive machine learning model 120 may also consider macroeconomic indicators, market trends, and financial data that often influence regulatory decisions. The predictive machine learning model 120 can also collect and be trained on political and social data such as information from public developments, social movements, and lobbying efforts that may provide context on potential regulatory focus areas. The predictive machine learning model 120 may also collect and be trained on news articles, expert opinions, and industry analyses that provide real-time insights into possible future regulatory changes.

Based on the collected information, the predictive machine learning model 120 may generate additional documents that may be processed utilizing the operations discussed in relation to the rule builder engine 110. For example, the predictive machine learning model 120 may generate a predicted regulatory document that the predictive machine learning model 120 predicts will be a likely regulation based on the training data. This document may be provided to semantic parser 114, DSL mapper 116, and rule compiler 118 to generate an executable rule based on the predicted regulation. This predicted rule may be stored in rules repository 106 for use by rule execution engine 122 at future processing steps. In this way, the computing environment 100 of FIG. 1 and the operations performed by rule builder engine 110 enable a prediction of future regulatory requirements that an enterprise may utilize to evaluate how they are complying or not complying with processing of user data.

After compiling the DSL rules to generate a set of executable rules, the executable rules may be stored in rules repository 106. Similar to database 102, rules repository 106 may be a remote storage location (e.g., as part of a cloud computing system) and one or more of the rule builder engine 110 or rule execution engine 122 may access the rules repository 106 to perform the operations described herein (e.g., store executable rules in the case of the rule builder engine 110 or access executable rules in the case of the rule execution engine 122). Storing the executable rules in a centralized rules repository 106 improves upon computer efficiencies as individual computing devices do not need to locally store the executable rules. Rather, all executable rules may be accessed and retrieved from rules repository 106 for use by computing devices in a computing network of an enterprise.

Staying with FIG. 1, a sample rule 108 is provided to highlight one or more aspects of the present disclosure. Sample rule 108 is provided as an example and is not intended to limit the present disclosure. As shown, sample rule 108 can include various fields such as a description of the rule. Sample rule 108 illustrates a higher-level abstraction of the executable rule, such as the rule generated after the processing steps associated with the DSL mapper 116. Included in sample rule 108 can be a description. The description of the rule can be associated with a type of regulation that sample rule 108 corresponds to. In the particular example shown in FIG. 1, sample rule 108 may correspond to a complaint reporting regulation where the complaint reporting is associated with various complaint types such as trading complaints, account complaints, and service complaints.

Sample rule 108 also includes the particular regulation that the rule is associated with. For example, the regulation may be a FINRA regulation, as discussed above. Sample rule 108 also includes the conditions from the regulation. In the particular example of complaint reporting, the regulatory requirement involves evaluating whether the complaint was received within fifteen days. The sample rule 108 also includes various action fields with various levels of importance based on the regulation. As shown by sample rule 108, the executable rules stored in rules repository 106 represent a structured rule about regulatory requirements and is converted into a language that is human readable. Sample rule 108 is in text. The text is readable by a human as if in a sentence form. Alternatively, the text is readable by a human as in a program or computer language form, such as C++. As shown, the executable rules represent a regulatory requirement. A user may delete, edit, or add any human readable input to the executable rules to thereby modify the rules. Additionally, a user may access the rules repository 106 to extract a list of rules for the user to use or evaluate.

Rule execution engine 122 is also included in computing environment 100. Rule execution engine 122 can evaluate evaluation data 104 using the executable rule retrieved from rules repository 106 to evaluate compliance of the enterprise with the regulations. Thus, rule execution engine 122 can process the executable rules and check for any violations or non-compliance issues and provide a response (e.g., compliance/non-compliance indication) to services 130. To process the executable rules, such as sample rule 108, rule execution engine 122 complies the executable rules back to its machine executable rule format (e.g., as represented by rule compiler 118). A computer language, such as the FRSL DSL, incorporates logic for interacting with the executable rules, such as including calls to specific fields, reading links, or extraction of data. The language is used to interact with the executable rules to execute the rules against evaluation data 104.

Services 130 can include various downstream service operators such as an API operation, a message queue, or a file system that may record or take further action based on the generated response from rule execution engine 122. The generated response thus may be output to a user, system, program, processor, memory, network, or other entity. For example, automated alerts and notifications may be generated based on the response where service 130 includes an alert mechanism to a user or team to notify the user or team of potential compliance breaches in real-time or near real-time thereby enabling faster response and resolution. The alert may also include an intervention or task suggestion to remediate the alert. Thus, the rule execution engine 122 interacts with the evaluation data 104 and the executable rules to answer higher level questions (e.g., “was the enterprise compliant in reporting the complaint”). More specific executable rules may be provided as well, such as “did the enterprise report the complaint within fifteen days?”

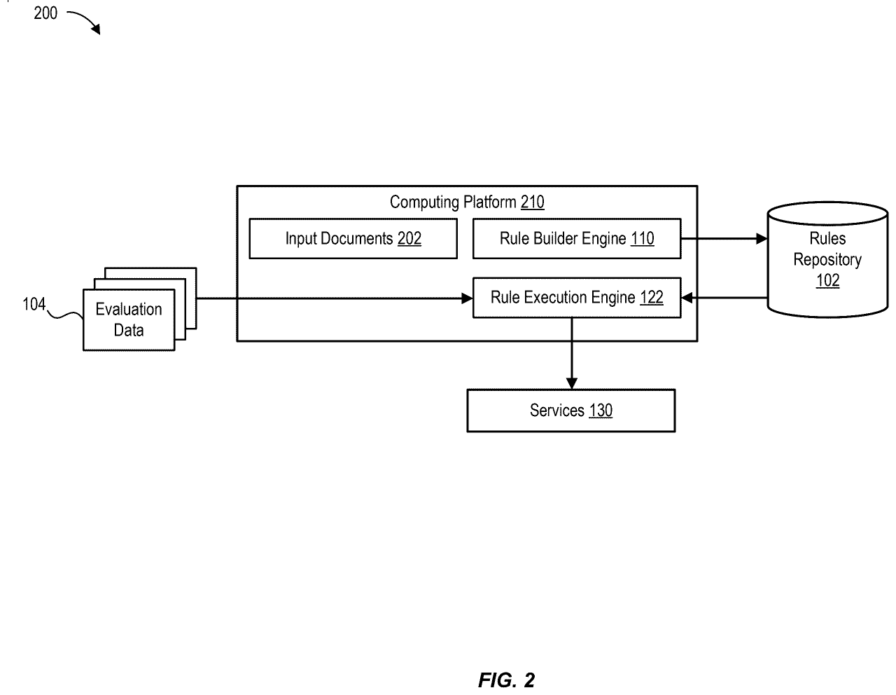

FIG. 2 is a block diagram illustrating an example computing platform 210 for rules management using a DSL, according to one or more aspects of the present disclosure. The computing environment 200 may include a computing platform 210. In an example the computing platform 210 may run on a client computer, while services 130, evaluation data 104, and rules repository 106 are run or stored on remote computing devices, such as in a cloud computing system. In other examples, one or more of the services 130, evaluation data 104, and rules repository 106 may also be run locally on the client computer such as computing platform 210.

The computing platform 210 may provide access to the input documents 202 by the rule builder engine 110, which may include rule builder engine 110 described in relation to FIG. 1. Further, outputs of the rule builder engine 110, such as the executable rules, may be stored in rules repository 106. Computing platform 210 may also provide access to rules repository 106 by rule execution engine 122, which may include rule execution engine 122 describe in relation to FIG. 1. In an example, evaluation data 104 may be accessed by computing platform 210 by rule execution engine 122. In other examples, evaluation data 104 may be stored in a database of the computing platform 210 (not shown) in a manner that enables access to the evaluation data 104 by the rule execution engine 122. Similarly, input documents 202 may be stored in a database of the computing platform 210 in a manner that enables access to the input documents 202 by the rule builder engine 110.

The rule builder engine 110 can include other microservices such as the NLP model 112, semantic parser 114, DSL mapper 116, rule compiler 118, and predictive machine learning model 120 described in relation to FIG. 1. In other words, rule builder engine 110 may run the microservices of the rule builder engine 110 to generate executable rules for access by rule execution engine 122. Similarly, rule execution engine 122 may access the executable rules stored in rules repository 106 and evaluate evaluation data 104 against the executable rules to determine compliance or non-compliance with the regulatory requirements associated with the executable rules. The output generated by the rule execution engine 122 may be provided downstream to services 130.

As previously mentioned, services 130 can include various downstream operators or use cases depending on the generated response from the rule execution engine 122. For example, services 130 can include an API operation, a message queue, or a file system that may record or take further action based on the generated response from rule execution engine 122. For example, the message queue of services 130 can include an automated alert mechanism to send an alert (e.g., message) to a user, a team, or a separate computing device depending on the response. In the case where evaluation data 104 is evaluated with an executable rule and the rule execution engine 122 determines that the enterprise is not compliant with the regulation associated with the executable rule, the message queue may generate an alert with an important flag level (e.g., low, medium, high) to the relevant entity or computing device with a suggested course of action. Thus, this proactive approach can detect and address potential compliance issues in real-time or near real-time offering a dynamic compliance management mechanism in an enterprise setting.

The techniques also enable faster response and resolution to identify issues.

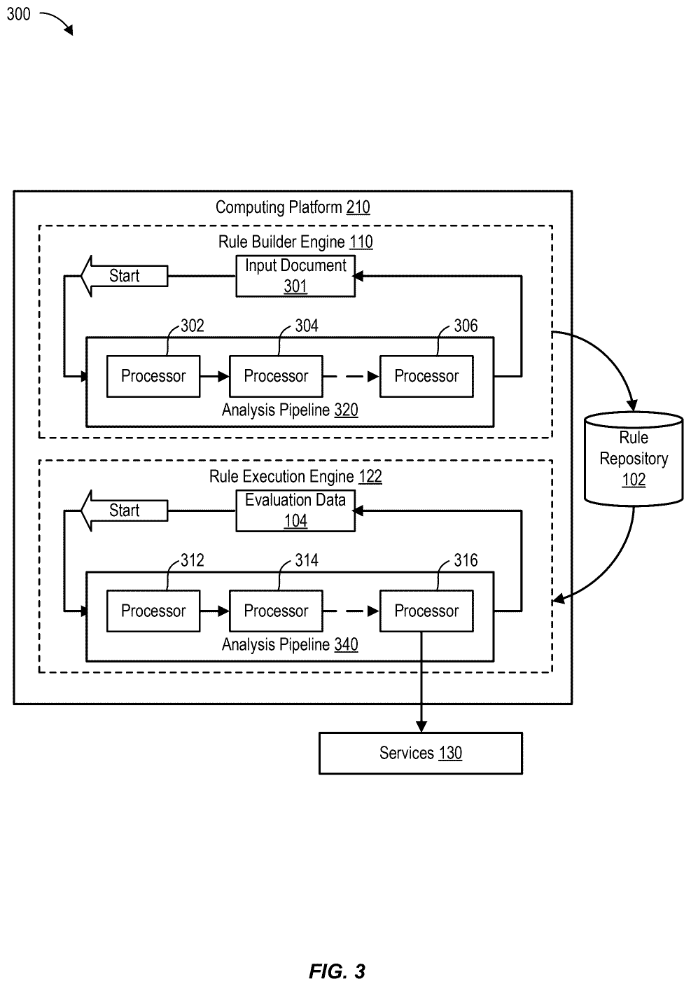

FIG. 3 is a block diagram illustrating an example analysis pipeline 300 of the computing platform of FIG. 2 used for rules management, according to one or more aspects of the present disclosure. As shown in FIG. 3, an input document 301 may be added as input to rule builder engine 110. Input document may be retrieved from a publicly accessible data source, such as database 102. Upon receipt of input document 301 at the computing platform 210, the analysis pipeline 320 processes the input document 301. In an example, the analysis pipeline 320 can include multiple processors 302 and 304 to process the input document 301. For example, processor 302 may perform the operations associated with the NLP model 112, processor 304 may perform the operations associated with the semantic parser 114, and so on. Other operations, such as the operations performed by the DSL mapper 116, may be performed by one of the processors 302 or 304, or the other operations may be performed by additional processors (not illustrated) of the analysis pipeline 320.

After processing input document 301, a processor 306 may store the executable rule in rules repository 106. As discussed above with respect to FIGS. 1 and 2, rules repository 106 can store various executable rules associated with various regulatory requirements extracted from input document 301. Further, as shown in FIG. 3, the process of evaluating input document 301 is a continuous process utilizing a feedback look. Thus, the rule builder engine 110 is continuously extracting new documents from the various data sources (e.g., the data sources described in relation to FIGS. 1 and 2) and performing the processing operations on the new documents to generate executable rules. Additionally, the feedback loop illustrated in conjunction with analysis pipeline 320 enables a cleaning and normalization of the executable rules to ensure consistency and accuracy. For example, different versions of regulatory requirements may be compared as part of the analysis pipeline 320 and irrelevant or duplicate information would be removed. As such, the executable rules stored in rules repository 106 would not contain duplicates or redundant rules. This feedback loop and continual learning process improves upon the efficiency of computing devices as the rule builder engine 110 may automatically update executable rules or remove other executable rules depending on the analysis thereby reducing the amount of human intervention involved.

Staying with in FIG. 3, after generation and storing of executable rules in rules repository 106, the executable rules may be accessed by rule execution engine 122. Evaluation data 104 may be added as input to rule execution engine 122. Upon receipt of evaluation data 104 at rule execution engine 122 of the computing platform 210, analysis pipeline 340 processes the evaluation data 104. Similar to analysis pipeline 320, analysis pipeline 340 can include multiple processors 312 and 314 to process the evaluation data 104 using the executable rules. For example, processor 312 may perform the operations associated executing the executable rule against evaluation data 104, processor 314 may perform operations associated with organizing the generated output into a structured format, such as a table, and so on. After processing the evaluation data 104, a processor 316 of analysis pipeline 340 may request an operator, such as services 130. As discussed above with respect to FIGS. 1 and 2, services 130 can include an API operation, a message queue, or a file system that may record or take further action based on the generated response from rule execution engine 122.

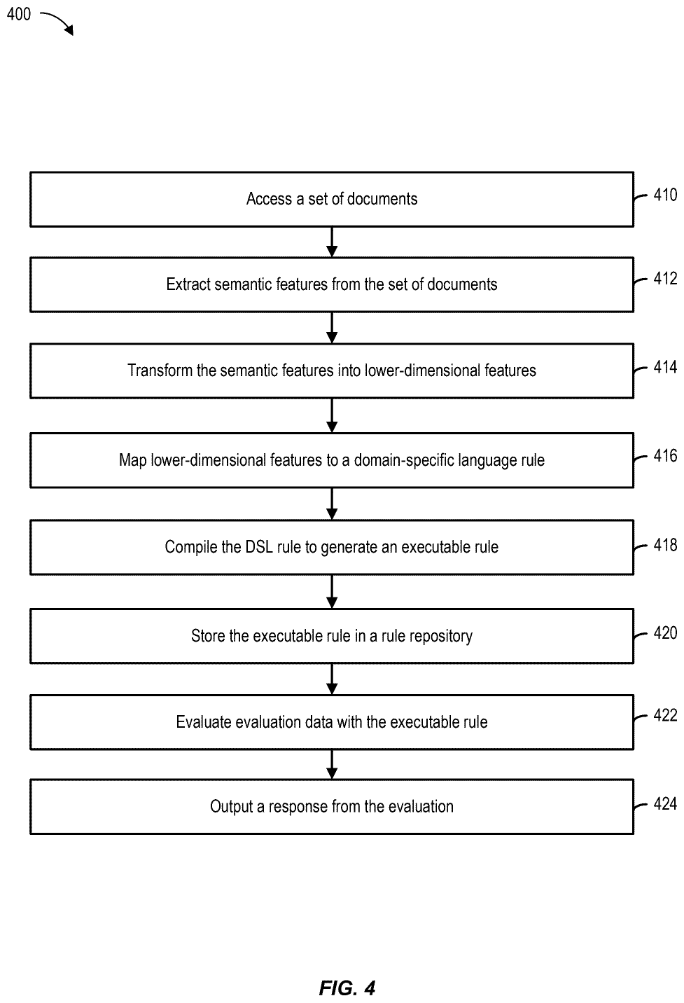

FIG. 4 is a flowchart of an example of a process 400 for rules management using a DSL, according to one or more aspects of the present disclosure. The steps illustrated by process 400 may be performed, for example, by one or more processors of a computing device operating as a separate system, such as rule builder engine 110 and rule execution engine 122 of FIG. 1, or as part of a computing platform, such as computing platform 210 of FIG. 2. For the sake of simplicity, the steps illustrated in process 400 and described below, are described in relation to being performed by a processor, although variations and other configurations are possible. Additionally, process 400 is provided in the order shown, but other orders or additional steps may be provided.

As illustrated, process 400 may begin at block 410 in which a processor can access a set of documents. In some examples, the set of documents can comprise text data associated with regulatory requirements published by a financial regulatory agency. In some examples, the set of documents can be associated with news articles, expert opinions, industry analyses, social media posts, financial data, information from political developments, social movements, macroeconomic indicators, market trends, etc. that may be scraped from government websites, regulatory bodies, legal databases, and other authoritative sources that may provide insight into past, current, and future regulatory requirements. The set of documents can be accessible (e.g., stored) in a database, such as database 102 described in relation to FIG. 1. The set of documents may also be stored in more than one publicly available databases. The set of documents thus may be stored in a manner that enables access to the documents by rule builder engine 110. Once accessed by the processor, the set of documents may be stored locally within rule builder engine 110. Alternatively, rule builder engine 110 may access the set of documents from a remote storage system.

In one example, process 400 can further involve periodically querying publicly accessible data sources to identify new documents to be added to the set of documents. Periodically querying the publicly accessible data sources can involve comparing the newly identified documents (e.g., the semantic features of the newly identified documents) against the initial set of documents to determine whether the any of the newly added documents are unique from the set of documents (e.g., representing a new regulatory requirement associated with a predefined policy published by a regulatory agency) or whether any of the newly added documents provide an update to one of the pre-existing documents of the set of documents. In one example, where a newly added document is associated with an update to a pre-existing document, process 400 may proceed to update the set of documents to remove the pre-existing document and include the newly added document containing the update. In one example, where a newly added document is a unique document representing a new regulatory requirement, process 400 may proceed to update the set of documents to include all the pre-existing documents as well as the newly added document corresponding to the new regulatory requirement thereby increasing the size (e.g., number of documents) of the set of documents.

At block 412, the processor can extract semantic features from the set of documents. For example, the NLP model 112 of the rule builder engine 110 may identify characters or words in the set of documents using a feature extraction technique. In other words, the NLP model 112 may extract the semantic features of the set of documents to thereby generate a set of semantic features corresponding to individual documents from the set of documents. The NLP model 112 can be trained to identity and extract semantic features associated with regulatory requirements. The NLP model 112 may perform various feature extraction techniques on the set of documents. As described above in relation to FIG. 1, the NLP model 112 may perform feature extraction using a BERT based feature extraction tool. BERT based featured extraction algorithms utilized by NLP model 112 may analyze sequential data (e.g., sentences within the set of documents) and understand context by analyzing the entire sequence of words rather than analyzing the text data word by word. In general, BERT based feature extraction functions by tokenizing the text data of the set of documents and converting the tokens to embeddings that capture the semantic meanings. Multiple layers of the BERT based algorithms refine the embeddings and various weightings are applied depending on the importance of different words in the documents. The semantic features extracted from the set of documents are then be provided to the semantic parser 114.

Additionally, and as described above, a second model, such as predictive machine learning model 120 of rule builder engine 110, may receive as input the set of documents. The predictive machine learning model 120 may use the set of documents to formulate a prediction about future trends of regulatory requirements associated with the set of documents and generate a predicted set of documents. More particularly, the predictive machine learning model 120 can generate a set of documents having a predicted set of semantic features based on one or more determined patterns associated with the input set of documents. The predicted semantic features from the set of predicted documents as well as the semantic features extracted from the input set of documents, as described above, may be provided to the semantic parser 114.

At block 414, the processor can transform the semantic features into lower-dimensional features. The semantic features generated by one or more of the NLP model 112 or the predictive machine learning model 120 may be high-dimensional in nature. In other words, the semantic features associated with the set of documents or predictive set of documents that are numerically represented via the feature extraction of the NLP model 112 or the predictive machine learning model 120 may have hundreds or even thousands of dimensions. For example, in the case of a BERT based feature extraction algorithm utilized by NLP model 112, each semantic feature may be represented with 768 dimensions to capture the semantic meaning of the input documents. As such, the semantic features can be transformed into a set of lower-dimensional features. Various tools may be utilized by semantic parser 114 to transform the semantic features into a set of lower-dimensional features such as UMAP or SVD techniques as described in relation to FIG. 1.

At block 416, the processor can map the lower-dimensional features to a domain-specific language rule. For example, the lower-dimensional features can be mapped into actionable insights or decisions based on specific knowledge or regulations relevant to a particular domain. As an example, a lower-dimensional feature extracted from a document from the set of documents may specify a timeframe where a complaint received by a financial institution must be reported to a regulatory agency (e.g., the FINRA or SEC). At block 416, the processor can map these extracted semantic features (e.g., “within fifteen days of receipt” or “within 1 business day”) to a specific DSL rule.

At block 418, the processor can compile the DSL rule to generate an executable rule. For example, the rule compiler 118 can take as input the FRSL DSL rules generated by the DSL mapper 116 and compile the rules into a set of executable rules that can be processed by the rule execution engine 122. In other words, the rule compiler 118 evaluates each DSL rule generated by the DSL mapper 116. Each line of the DSL rule is converted from the source code associated with DSL mapper 116 (e.g., a higher level of abstraction) into machine readable code (e.g., bytecode, computer-readable media, etc.). Thus, the rule compiler 118 prepares the DSL rules to be executed by the rule execution engine 122.

At block 420, the processor can store the executable rule in a rule repository. For example, rules repository 106 can store various executable rules associated with various regulatory requirements extracted from the set of documents and transformed into FRSL DSL rules. These rules may be stored as a part of rule execution engine 122 or may otherwise be accessible by rule execution engine 122 (e.g., from a remote storage location).

At block 422, the processor can evaluate evaluation data with the executable rule. For example, rule execution engine 122 can receive evaluation data 104 as input. Evaluation data 104 can correspond to user data, customer complaints, financial transaction records, etc. received by a financial institution through the course of business. The rule execution engine can evaluate the evaluation data 104 using an appropriate executable rule extracted or retrieved from the rules repository 106.

At block 424, the processor can output a response from the evaluation. For example, the rule execution engine 122 can evaluate the evaluation data 104 using the executable rule and generate a response indicating compliance or non-compliance, for example. The generated response may then be provided to a downstream service operator such as services 130. As previously described, services 130 can be associated with an API operator, a message queue, and a file system; however, other services 130 associated with an enterprise are possible. The generated response may be output to a user, system, program, processor, memory, network, or other entity. The generated response generated by rule execution engine 122 may provide real-time or near real-time evaluations of compliance/non-compliance of an enterprise with the various regulatory requirements or predictions of regulatory requirements that have been formed into domain-specific language executable rules at previous processing steps. This enables more efficient (e.g., less manual intervention and faster processing) and more accurate interpretation of compliance. This can save manual labor costs down at future processing steps by eliminating or reducing the need to identity instances of compliance since the instances are automatically reported.

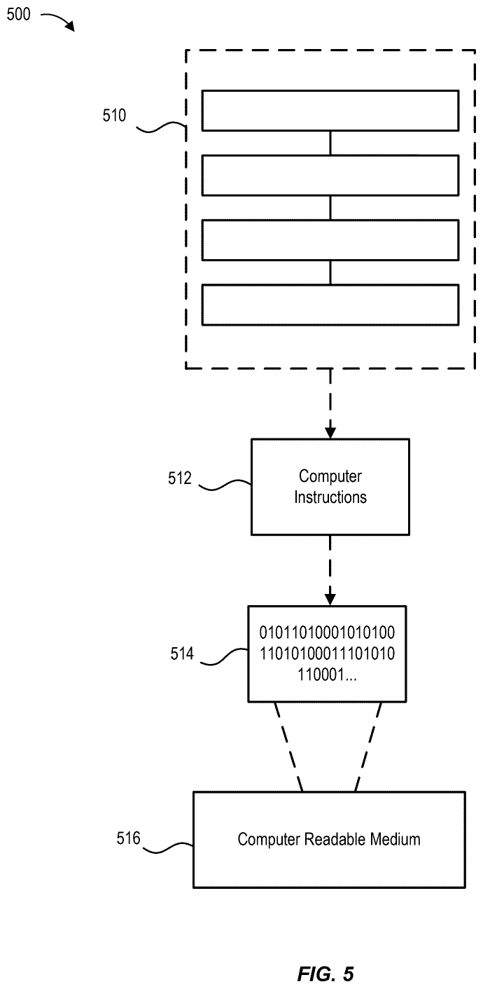

One or more of the aspects of the present disclosure include a computer-readable medium including microprocessor or processor-executable instructions configured to implement one or more embodiments presented herein. FIG. 5 is a block diagram illustrating an example computer-readable medium or computer-readable device including processor-executable instructions configured to embody one or more of the aspects set forth herein. As illustrated in FIG. 5, implementation 500 includes a computer-readable medium 516. Computer-readable medium 516 can include a CD-R, DVD-R, flash drive, a platter of a hard disk drive, and so forth, on which computer-readable data 514 is encoded and stored. The computer-readable data 514, such as binary data including a plurality of zero's and one's as illustrated, in turn includes a set of computer instructions 512 configured to operate according to one or more of the principles set forth herein.

In the illustrated implementation 500 of FIG. 5, the set of computer instructions 512 (e.g., processor-executable computer instructions) may be configured to perform a method 510, such as the process 400 of FIG. 4, for example. In another embodiment, the set of computer instructions 512 may be configured to implement a system, such as rule builder engine 110 or the rule execution engine 122 of FIG. 1, for example. Many such computer-readable media may be devised by those of ordinary skill in the art that are configured to operate in accordance with the techniques presented herein.

As used in this application, the terms “component,” “module,” “system,” “interface,” “manager,” and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

A device may also be called and may contain some or all of the functionality of a system, subscriber unit, subscriber station, mobile station, mobile, mobile device, wireless terminal, device, remote station, remote terminal, access terminal, user terminal, terminal, wireless communication device, wireless communication apparatus, user agent, user device, or user equipment (UE). A mobile device may be a cellular telephone, a cordless telephone, a Session Initiation Protocol (SIP) phone, a smart phone, a feature phone, a wireless local loop (WALL) station, a personal digital assistant (PDA), a laptop, a handheld communication device, a handheld computing device, a netbook, a tablet, a satellite radio, a data card, a wireless modem card, and/or another processing device for communicating over a wireless system. Further, although discussed with respect to wireless devices, the disclosed aspects may also be implemented with wired devices, or with both wired and wireless devices.

Further, the claimed subject matter may be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

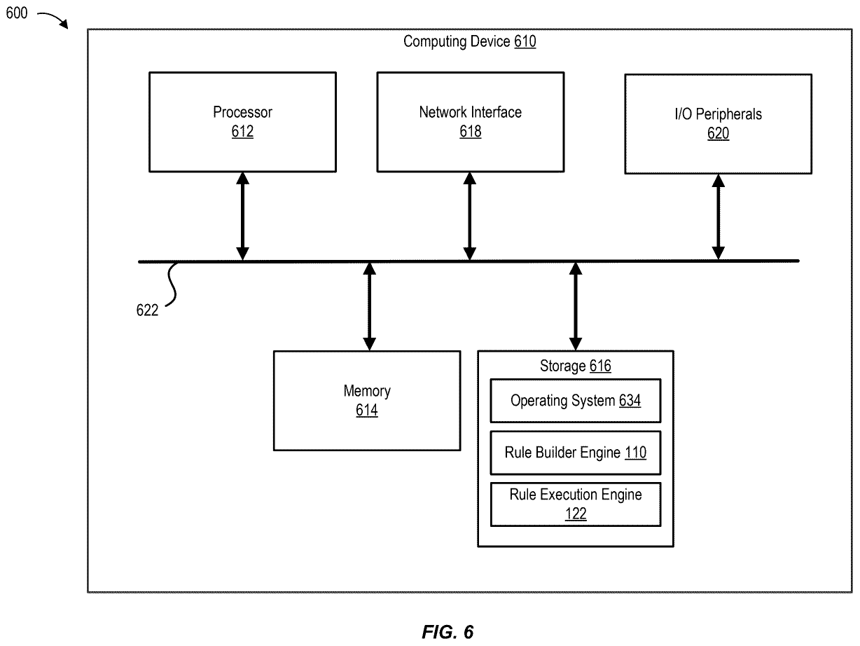

FIG. 6 and the following discussion provide a description of a suitable computing environment 600 to implement embodiments of one or more aspects of the present disclosure. The computing environment 600 of FIG. 6 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini-computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, application programming interfaces (APIs), data structures, and the like, which perform one or more tasks or implement one or more abstract data types. Typically, the functionality of the computer readable instructions is combined or distributed as desired in various environments.

FIG. 6 is a block diagram illustrating an example computing environment 600 for implementing financial regulatory and compliance rules management using a customized DSL, according to one or more aspects of the present disclosure. In one configuration, the computing device 610 may include at least one processor 612 and at least one memory 614. Depending on the exact configuration and type of computing device, the at least one memory 614 may be volatile, such as RAM, non-volatile, such as ROM, flash memory, etc., or a combination thereof. Examples of processor 612 include a microprocessor, an application-specific integrated circuit (ASIC), a field-programmable gate array (FPGA), or any other suitable processing device. Computing device 610 can include one processor, such as is illustrated by processor 612 in FIG. 6, or more than one processor.

Computing device 610 may include additional features or functionality. For example, the computing device 610 may include storage such as removable storage or non-removable storage, including, but not limited to, magnetic storage, optical storage, etc. Such storage is illustrated in FIG. 6 by storage 616. In one or more embodiments, computer readable instructions to implement one or more embodiments provided herein are in the storage 616. The storage 616 may store other computer readable instructions to implement an operating system, an application program, etc. Computer readable instructions may be loaded in the at least one memory 614 for execution by the at least one processor 612, for example.

Computing devices may include a variety of media, which may include computer-readable storage media or communications media, which two terms are used herein differently from one another as indicated below.

Computer-readable storage media may be any available storage media, which may be accessed by the computer and includes both volatile and nonvolatile media, removable and non-removable media. By way of example, and not limitation, computer-readable storage media may be implemented in connection with any method or technology for storage of information such as computer-readable instructions, program modules, structured data, or unstructured data. Computer-readable storage media may include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which may be used to store desired information. Computer-readable storage media may be accessed by one or more local or remote computing devices (e.g., via access requests, queries, or other data retrieval protocols) for a variety of operations with respect to the information stored by the medium.

Communications media typically embody computer-readable instructions, data structures, program modules, or other structured or unstructured data in a data signal such as a modulated data signal (e.g., a carrier wave or other transport mechanism) and includes any information delivery or transport media. The term “modulated data signal” (or signals) refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Still referring to FIG. 6, the computing environment 600 may also include a number of additional external or internal devices, for example, input or output devices. For example, computing device 610 is illustrated as including input/output (I/O) peripherals 620. I/O peripherals 620 can receive input from an input device (not shown) or provide output to output devices (not shown). Input peripherals can include a variety of different input devices such as keyboards, mouses, pens, voice input devices, touch input devices, infrared cameras, video input devices, or any other input device. Output peripherals can include a variety of different output devices such as one or more displays, speakers, printers, or any other output device may be included with the computing device 610.

I/O peripherals 620 may be connected to the computing device 610 via a wired connection, wireless connection, or any combination thereof. Further, the computing device 610 may include network interface 618 to facilitate communications with one or more other devices (not shown). Network interface 618 can include any device or group of devices suitable for establishing a wired or wireless data connection to one or more data networks. Non-limiting examples of the network interface 618 include an Ethernet network adaptor, a wireless network adapter, a modem, Wi-Fi adapter, Bluetooth adapter, near field communication (NFC) receiver and transmitter, and any other known wired or wireless data transmission system.

Computing device 610 also includes interface bus 622. Although only one interface bus is illustrated, computing environment 600 can include more than one interface bus. Interface bus 622 can communicatively couple one or more components of computing device 610. Computing environment 600 also includes one or more programs and/or program data that may be accessible in storage 616 by the computing device 610. For example, storage 616 can store an operating system 634 utilized to control the operation of the computing device 610. Storage 616 can also store other system application programs and data utilized by the computing device 610, such as modules implementing the functionalities provided by the rule builder engine 110 or the rule execution engine 122 or any other functionalities described above with respect to FIGS. 1-4. The storage 616 may also store other programs and data not specifically identified herein.

### General Considerations

Numerous specific details are set forth herein to provide a thorough understanding of the claimed subject matter. However, those skilled in the art will understand that the claimed subject matter may be practiced without these specific details. In other instances, methods, apparatuses, or computing systems that would be known by one of ordinary skill have not been described in detail so as not to obscure claimed subject matter.

Unless specifically stated otherwise, it is appreciated that throughout this specification discussions utilizing terms such as “generating,” “processing,” “computing,” and “determining” or the like refer to actions or processes of a computing device, such as one or more computers or a similar electronic computing device or devices that manipulate or transform data represented as physical electronic or magnetic quantities within memories, registers, or other information storage devices, transmission devices, or display devices of the computing platform.

The computing system or computing systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes,” “having,” “has,” “with,” or variants thereof are used in either the detailed description or the claims, such terms are intended to be inclusive in a manner similar to the term “comprising.” The use of “configured to” or “based on” herein is meant as open and inclusive language that does not foreclose devices adapted to or configured to perform additional tasks or steps. The endpoints of comparative limits are intended to encompass the notion of quality. Thus, expressions such as “more than” should be interpreted to mean “more than or equal to.”

Where devices, computing systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation and does not preclude inclusion of such modifications, variations, and/or additions to the present subject matter as would be readily apparent to one of ordinary skill in the art.

What is claimed is:

1. A method comprising:
accessing a first set of documents comprising text data;
extracting a set of semantic features from the first set of documents using a first natural language processing (NLP) model of a rule builder engine, wherein each document from the first set of documents includes one or more semantic features;
transforming the set of semantic features into a set of lower-dimensional features using a semantic parser of a rule builder engine;
mapping the lower-dimensional features to a domain-specific language (DSL) rule to thereby generate a set of DSL rules;
compiling the set of DSL rules using a rules compiler module of the rules building engine to generate a set of executable rules;
storing the set of executable rules in a rules repository for access by a rule execution engine, wherein one or more executable rules are executed against one or more documents from a second set of documents received by the rule execution engine to generate a response; and
providing the response to a downstream operating service.

2. The method of claim 1, wherein the first set of documents are stored in a publicly accessible database, and wherein a first document of the first set of documents is associated with a first predefined policy and a second document of the first set of documents is associated with a second predefined policy.

3. The method of claim 2, further comprising:
querying the publicly accessible database to identify a third document associated with a third predefined policy;
comparing the third predefined policy of the third document to one or more of the first predefined policy or the second predefined policy to determine whether the third predefined policy is associated with an update to the first predefined policy or the second predefined policy or whether the third predefined policy is a new predefined policy;
updating the first set of documents to include the third document and to remove one or more of the first document or the second document when the third predefined policy is associated with an update to the first predefined policy or the second predefined policy; and
updating the first set of documents to include the first document, the second document, and the third document when the third predefined policy is a new predefined policy.

4. The method of claim 3, wherein querying the publicly accessible database is performed periodically.

5. The method of claim 1, further comprising:
providing the first set of documents to a second NLP model of the rule builder engine, wherein the second NLP model is trained to identify one or more patterns associated with the first set of documents;
generating, using the second NLP model, a third set of documents having a predicted set of semantic features, and wherein the third set of documents is generated based on one or more patterns associated with the first set of documents;
providing the predicted set of semantic features to the semantic parser of the rule builder engine to generate a second set of lower-dimensional features;
mapping the second set of lower-dimensional features to the domain-specific language (DSL) rule to thereby generate a predicted set of DSL rules;
compiling the predicted set of DSL rules using the rules compiler module to generate a set of predicted executable rules; and
storing the set of predicted executable rules in the rules repository for access by a rule execution engine.

6. The method of claim 1, wherein the second set of documents is associated with user financial data, and wherein the response is associated with an alert of compliance or non-compliance with a predefined policy associated with at least one document of the first set of documents.

7. The method of claim 6, wherein the downstream operating service comprises a message queue, and wherein the method further comprises:
generating an alert based on the response, wherein the alert is automatically generated by the rule execution engine, and wherein the alert is posted to the message queue.

8. The method of claim 1, further comprising:
modifying one or more of the executable rules using a user interface of the downstream operating service and based on user adjustable parameters to create a modified executable rule; and
storing the modified executable rule in the rules repository.

9. A system comprising:
one or more processors;
a memory coupled to the one or more processors, the memory including instructions that, when executed by the one or more processors, cause the one or more processors to:
access a first set of documents comprising text data;
extract a set of semantic features from the first set of documents using a first natural language processing (NLP) model of a rule builder engine, wherein each document from the first set of documents includes one or more semantic features;
transform the set of semantic features into a set of lower-dimensional features using a semantic parser of a rule builder engine;
map the lower-dimensional features to a domain-specific language (DSL) rule to thereby generate a set of DSL rules;
compile the set of DSL rules using a rules compiler module of the rules building engine to generate a set of executable rules;
store the set of executable rules in a rules repository for access by a rule execution engine, wherein one or more executable rules are executed against one or more documents from a second set of documents received by the rule execution engine to generate a response; and
provide the response to a downstream operating service.

10. The system of claim 9, wherein the first set of documents are stored in a publicly accessible database, and wherein a first document of the first set of documents is associated with a first predefined policy and a second document of the first set of documents is associated with a second predefined policy.

11. The system of claim 10, wherein the instructions further cause the one or more processors to:
query the publicly accessible database to identify a third document associated with a third predefined policy;
compare the third predefined policy of the third document to one or more of the first predefined policy or the second predefined policy to determine whether the third predefined policy is associated with an update to the first predefined policy or the second predefined policy or whether the third predefined policy is a new predefined policy;
update the first set of documents to include the third document and to remove one or more of the first document or the second document when the third predefined policy is associated with an update to the first predefined policy or the second predefined policy, ; and
update the first set of documents to include the first document, the second document, and the third document when the third predefined policy is a new predefined policy.

12. The system of claim 11, wherein querying the publicly accessible database is performed periodically.

13. The system of claim 9, wherein the instructions further cause the one or more processors to:
providing the first set of documents to a second NLP model of the rule builder engine, wherein the second NLP model is trained to identify one or more patterns associated with the first set of documents;
generating, using the second NLP model, a third set of documents having a predicted set of semantic features, and wherein the third set of documents is generated based on one or more patterns associated with the first set of documents;
providing the predicted set of semantic features to the semantic parser of the rule builder engine to generate a second set of lower-dimensional features;
mapping the second set of lower-dimensional features to the domain-specific language (DSL) rule to thereby generate a predicted set of DSL rules;
compiling the predicted set of DSL rules using the rules compiler module to generate a set of predicted executable rules; and
storing the set of predicted executable rules in the rules repository for access by a rule execution engine.

14. The system of claim 9, wherein the second set of documents is associated with user financial data, and wherein the response is associated with an alert of compliance or non-compliance with a predefined policy associated with at least one document of the first set of documents.

15. The system of claim 14, wherein the downstream operating service comprises a message queue, and wherein the instructions further cause the one or more processors to:
generate an alert based on the response, wherein the alert is automatically generated by the rule execution engine, and wherein the alert is posted to the message queue.

16. The system of claim 9, wherein the instructions further cause the one or more processors to:
modify one or more of the executable rules using a user interface of the downstream operating service and based on user adjustable parameters to create a modified executable rule; and
store the modified executable rule in the rules repository.

17. A non-transitory computer-readable medium embodying program code that is executable by one or more processors to cause the one or more processors to:
access a first set of documents comprising text data;
extract a set of semantic features from the first set of documents using a first natural language processing (NLP) model of a rule builder engine, wherein each document from the first set of documents includes one or more semantic features;
transform the set of semantic features into a set of lower-dimensional features using a semantic parser of a rule builder engine;
map the lower-dimensional features to a domain-specific language (DSL) rule to thereby generate a set of DSL rules;
compile the set of DSL rules using a rules compiler module of the rules building engine to generate a set of executable rules;
store the set of executable rules in a rules repository for access by a rule execution engine, wherein one or more executable rules are executed against one or more documents from a second set of documents received by the rule execution engine to generate a response; and
provide the response to a downstream operating service.

18. The non-transitory computer-readable medium of claim 17, wherein the first set of documents are stored in a publicly accessible database, and wherein a first document of the first set of documents is associated with a first predefined policy and a second document of the first set of documents is associated with a second predefined policy, and further comprising program code that is executable by the one or more processors to cause the one or more processors to:
query the publicly accessible database to identify a third document associated with a third predefined policy;
compare the third predefined policy of the third document to one or more of the first predefined policy or the second predefined policy to determine whether the third predefined policy is associated with an update to the first predefined policy or the second predefined policy or whether the third predefined policy is a new predefined policy;
update the first set of documents to include the third document and to remove one or more of the first document or the second document when the third predefined policy is associated with an update to the first predefined policy or the second predefined policy, ; and
update the first set of documents to include the first document, the second document, and the third document when the third predefined policy is a new predefined policy.

19. The non-transitory computer-readable medium of claim 17, further comprising program code that is executable by the one or more processors to cause the one or more processors to:
providing the first set of documents to a second NLP model of the rule builder engine, wherein the second NLP model is trained to identify one or more patterns associated with the first set of documents;
generating, using the second NLP model, a third set of documents having a predicted set of semantic features, and wherein the third set of documents is generated based on one or more patterns associated with the first set of documents;
providing the predicted set of semantic features to the semantic parser of the rule builder engine to generate a second set of lower-dimensional features;
mapping the second set of lower-dimensional features to the domain-specific language (DSL) rule to thereby generate a predicted set of DSL rules;
compiling the predicted set of DSL rules using the rules compiler module to generate a set of predicted executable rules; and
storing the set of predicted executable rules in the rules repository for access by a rule execution engine.

20. The non-transitory computer-readable medium of claim 17, wherein the second set of documents is associated with user financial data, and wherein the response is associated with an alert of compliance or non-compliance with a predefined policy associated with at least one document of the first set of documents, and further comprising program code that is executable by the one or more processors to cause the one or more processors to:
generate an alert based on the response, wherein the alert is automatically generated by the rule execution engine, and wherein the alert is posted to a message queue of the downstream operating service.
